(19) United States
(12) Patent Application Publication
(10) Pub. No.: US 2013/0227541 A1
(43) Pub. Date: Aug. 29, 2013

(54) UPDATING A WEB SERVICES DESCRIPTION LANGUAGE FOR A SERVICE TEST

(71) Applicants: Gal Shadeck, Kfar-Saba (IL); Guy Rosenthal, Ramat Gan (IL); Ran Kiselstein, Petah-Tikva (IL)

(72) Inventors: Gal Shadeck, Kfar-Saba (IL); Guy Rosenthal, Ramat Gan (IL); Ran Kiselstein, Petah-Tikva (IL)

(21) Appl. No.: 13/408,714

(22) Filed: Feb. 29, 2012

(51) Int. Cl. G06F 9/44

(52) U.S. Cl. 717/170

(57) ABSTRACT

Methods, systems, and computer-readable media with executable instructions stored thereon for updating a Web Services Description Language (WSDL) for a service test are provided. Updating a WSDL for a service test can include identifying a first WSDL and a second WSDL for a service and mapping the first WSDL to the second WSDL. Updating a WSDL for a service test can include performing an action to update a call within the service test from the second WSDL to the first WSDL.

### BACKGROUND

Service-Oriented Architecture (SOA) is a set of principles and methodologies for designing and developing software in the form of interoperable services. These services can define business functionalities that are built as components that can be reused for different purposes. An Extensible Markup Language (XML) based language, often called Web Services Description Language, can be used to describe the services in an SOA.

### BRIEF DESCRIPTION OF THE DRAWINGS

FIG. 1 is a flow chart illustrating an example of a method for updating a Web Services Description Language (WSDL) for a service test according to the present disclosure.

FIG. 2 is flow chart illustrating an example of a process for updating a WSDL for a service test according to the present disclosure.

FIG. 3 is a block diagram of an example of a computer-readable medium in communication with processing resources for updating a WSDL for a service test according to the present disclosure.

### DETAILED DESCRIPTION

Examples of the present disclosure include methods, systems, and computer-readable media with executable instructions stored thereon for updating a Web Services Description Language (WSDL) for a service test. A first WSDL and a second WSDL for a service can be identified, and the first WSDL can be mapped to the second WSDL. A call within the service test can be updated from a second WSDL to the first WSDL by performing an action.

A SOA can be comprised of functional components, often called services or Web services. A service can include a service-like application that exposes a public interface over the Web. Each service may implement one action and pass messages using description metadata, rather than embedding calls to one another. Services can be written in an XML-based language, called WSDL. WSDL can provide a computer-readable description of how one or more services can be called, what parameters each service may need, and what data structures each service may return. WSDL can describe services as a collection of network endpoints, or ports. A port can be defined by associating a network address with a reusable binding. The network endpoints or ports are defined protocols and functionalities of the interface of the SOA. For a service, WSDL can include XML schema, which can be used to express a set of rules to which an XML document must conform in order to be valid to the schema.

As businesses deploy more and more services in an SOA, the quality of the services through service testing can become inherently important. Testing of a service can require that a tester develop tests that depend upon the WSDL of the service. A test for a service can include a sequence of service operation calls, for which the request values and the expected response values are defined. However, services in an SOA can be in a constant flux. When a developer changes the WSDL of the service to create new versions and to fix errors, the changes can affect the WSDL. Once a WSDL for a service has been updated, the test created by the tester may not comply with the WSDL for the service. The tester may be required to rewrite the test for the service based on the updated WSDL.

By implementing a procedure to update the WSDL for a service test, the WSDL can be updated within service test call operations without requiring the tester to rewrite all tests for the service. The data that the tester may have used for sending requests or validating responses, as well as links between various steps, may be transferred from the previous WSDL version of the test to the updated WSDL version. Further, any discrepancies between the WSDLs can be displayed to the tester in a comprehensive fashion so that the tester can resolve any conflicts without a complete rewrite of the test.

In the present disclosure, reference is made to the accompanying drawings that form a part hereof, and in which is shown by way of illustration how one or more examples of the disclosure can be practiced. These examples are described in sufficient detail to enable those of ordinary skill in the art to practice the examples of this disclosure, and it is to be understood that other examples can be used and that process, electrical, and/or structural changes can be made without departing from the scope of the present disclosure.

The figures herein follow a numbering convention in which the first digit corresponds to the drawing figure number and the remaining digits identify an element or component in the drawing. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

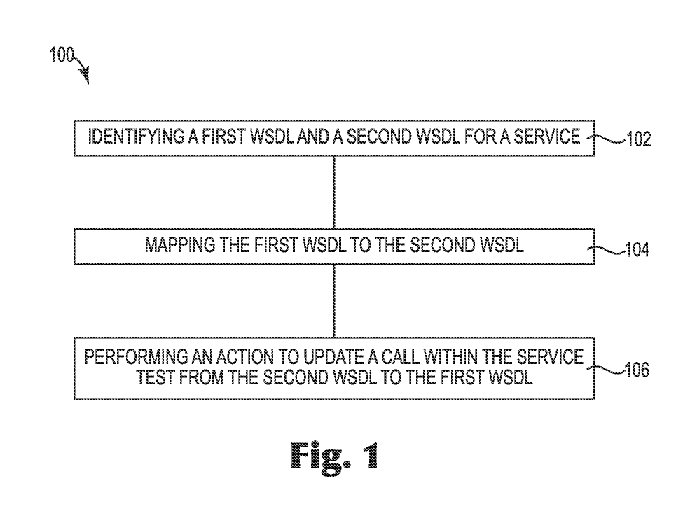

FIG. 1 is a flow chart illustrating an example of a method 100 for updating a WSDL for a service test according to the present disclosure.

The method 100 can update a WSDL call for a service within a service test without requiring a tester to rewrite the test for the service. A service test can include an input message that can be used as a parameter and/or property to invoke the service under the service test and an output message that is expected from the service. The actual output message can be compared to the expected output message to determine whether a service function is correct.

At 102, a first WSDL and a second WSDL for a service are identified. A first WSDL can include an updated version of a second WSDL, an updated WSDL, and/or an updated version of a WSDL, among others. An updated version of a second WSDL can include a modified version of the original WSDL, for instance. For example, an updated version of the second WSDL can include a change to the service name, service endpoint, port name, operation name, operation requests, and/or response schemas of the first WSDL. Identifying a first WSDL can include automatically detecting a second WSDL is updated and automatically detecting a change to the second WSDL, for example. A second WSDL can include a prior WSDL and a prior version of a WSDL, among others. The update to the second WSDL can be performed from the same location from which the second WSDL was originally imported or from a different location, for example. A different location can include a local file system, a local network, the web, and/or a repository, among others.

In various examples of the present disclosure, a user can choose to ignore the first WSDL or apply the first WSDL. A user can include a tester of the service or a quality and assurance tester, for example. In an example, a prompt may be displayed to the user in response to identifying a first WSDL and second WSDL. The prompt may include an option to ignore the first WSDL or apply the first WSDL.

If a user chooses to ignore the first WSDL, the test for the service may remain written under the second WSDL, for example. Ignoring the first WSDL can include, for example, ignoring a conflict between the first WSDL for the service and the call within the service test. A conflict can include a call for the service within the service test that does not comply with the WSDL of the service, for example. A call may not comply with the WSDL of the service, for instance, if there is a difference between a first WSDL for the service and a second WSDL used in a call for the service within a service test. For example, a service test may include a call to the service written to comply with an original WSDL (e.g. second WSDL and prior WSDL) for the service. A developer of the service may update the WSDL for the service (e.g. first WSDL and updated WSDL). A call to the service for the service test that remains written to comply with the original WSDL (e.g. ignore the first WSDL and ignore a conflict) may not comply with the service with the updated WSDL, and may result in the service test being prevented from running while the conflict exists.

If a user chooses to apply the first WSDL, the method 100 may continue with the process of updating the WSDL to the first WSDL (e.g. continue to the mapping step 104).

At 104, the first WSDL is mapped to the second WSDL. For example, mapping can include automatically mapping the second WSDL operation to a location in the first WSDL operation list. An operation can include a single method from the service interface and can define the formats of request and expected response data. A call can include, for example, a single invocation of an operation. A test for a service can include a sequence of service operation calls, for which the request values and the expected response values have been defined. Locating the operation of the second WSDL call can include determining that an operation with the same name, same port, and same service of the second WSDL call exists in the first WSDL. Various examples of method 100 can include mapping a plurality of second WSDL operations to a plurality of locations in the first WSDL operation list. The plurality of second WSDL operations can include, for example, all second WSDL operations for the service test.

At 106, an action can be performed to update a call within a service test from the second WSDL to the first WSDL. A call within a service test can include a call for the service within the service test, for example. Performing an action can include automatically converting the call from a second WSDL call to a first WSDL call, deleting the call, ignoring the first WSDL, and/or providing a manual update procedure, for example. For instance, converting a call can include converting all calls within the service test from the second WSDL to the first WSDL.

In various examples of the present disclosure, converting a call from a second WSDL call to a first WSDL call can include an automatic process if the location of the operation of the second WSDL call can be located in the first WSDL. In response to locating the operation of the second WSDL in the first WSDL, an XML schema validation can be performed, the properties of the second WSDL call can be mapped to the first WSDL call properties, and request and response data from the second WSDL call can be copied to the first WSDL call.

A first WSDL call can include a converted WSDL call, and a second WSDL call can include a prior WSDL call, for example. Call properties can include data, links, and checkpoints belonging to the input, output, faults, and attachments of an operation. For example, call properties can include parameters of the call operation. Request and response data can include values from the second WSDL call operation sent for request and/or validating responses that can be found in the first WSDL. Data that can be found in the first WSDL can include data that can be used in the first WSDL call operation, for example. For instance, request and response data can include all request and response data from the second WSDL call.

An XML schema can include a description of a type of XML document that can be expressed in terms of constraints on the structure and content of the document. Validation of an XML schema can include determining if an XML document conforms to a schema, or in other words, if the document is valid. For example, a document (e.g. service test call operation) may be valid if the document satisfies the requirements of the XML schema the document is associated with (e.g. the XML schema of the service). Requirements of the schema can include definitions of valid requests and response messages used to communicate with the service. Definitions of valid requests and response messages, for instance, can include a series of rules and constraints that the messages may be required to comply with for the messages to be deemed valid.

In some examples of the present disclosure, the method 100 can include prompting a user to decide whether to perform an action of deleting the call, ignoring the first WSDL, or performing a manual update procedure in response to the method 100 being unable to automatically convert the call from the second WSDL call to the first WSDL call. For example, the method 100 may be unable to convert the call if the first WSDL location of the second WSDL operation is not found or if request and response data cannot be copied from the second WSDL to the first WSDL. Copying response and request data may not occur, for instance, if the method 100 is unable to automatically map the properties of the second WSDL to the first WSDL call properties. For example, automatic mapping of properties may not occur when the first WSDL includes a change to the names of the ports for the service.

In some examples of the present disclosure, a manual procedure may include providing a list of all operations for the first WSDL of the service, and a user may choose an operation from the list to associate the call with.

In various examples of the present disclosure, a manual procedure may include providing a graphic on a user interface of properties of the second WSDL call that cannot be automatically mapped to the first WSDL call. Properties that cannot be mapped can include properties that cannot be located in the first WSDL call due to changes in name, data type, or location within the schema, for example. The graphic of the WSDL call properties that cannot be mapped can include a listing of all properties in the second WSDL call compared to all properties of the first WSDL call.

The method 100 can include automatically transferring security settings from the second WSDL to the first WSDL, in various examples of the present disclosure. Security settings can include parameter values for a port of the second WSDL and service test call properties, for instance. For example, security settings can be transferred from ports of the second WSDL to ports of the first WSDL. In some examples, the method 100 may be unable to automatically transfer a security setting and may provide a manual procedure for transferring the security setting. For example, a security setting may not be able to transfer automatically if the first WSDL includes a change to the names of the ports for the service.

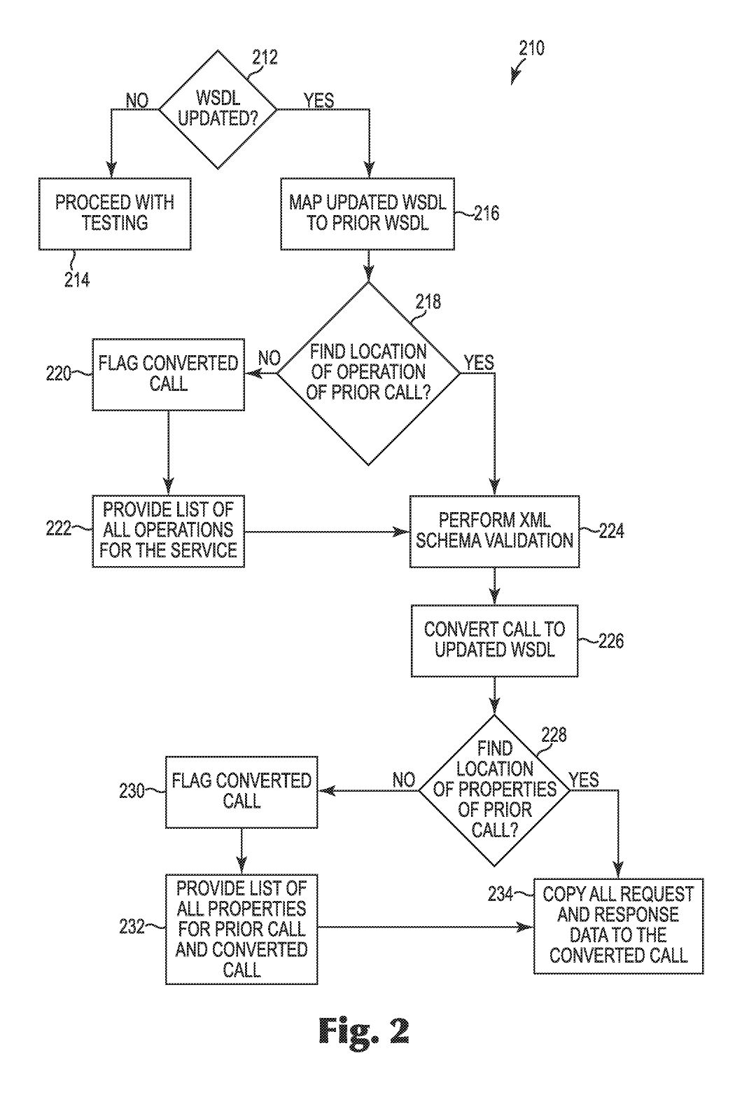

FIG. 2 is a flow chart illustrating an example of a process 210 for updating a WSDL for a service test according to the present disclosure.

At 212, a determination can be made as to whether a WSDL for a service is updated. The determination can include automatically detecting a change to a service name, service endpoint, port name, operation name, operation request, and response request of a prior WSDL for a service, among many others. A prior WSDL can include a prior version of the updated WSDL, for example. In response to determining a WDSL has not been updated for a service, at 214, the tester can proceed with testing.

At 218, a determination can be made as to whether the location of the operation of the prior WSDL call can be located in the updated WSDL operation list. Determining the location of the operation of the prior call can include determining if the same operation exists in the updated WSDL. For example, the same operation can include an operation with the same name, belonging to the same port, and/or belonging to the same service as the prior WSDL.

In response to not automatically determining the location of the operation of the prior call in the updated WSDL, at 220, the converted call can be flagged. Flagging a converted call can include visually marking the step as problematic and providing a user with a number of options to fix a problem with converting the call, for example. At 222, if a converted call has been flagged because of an inability to automatically locate the operation of the prior call in the updated WSDL operation list, a list of a plurality of the updated WSDL operations for the service can be provided to the user. The list of a plurality of operations can include all operations for the service in the updated WSDL. The list can be provided to a user for the user to select an updated WSDL operation from the list that should be mapped to a prior WSDL operation. A user can include a tester of the service or a quality and assurance tester, for example.

In response to determining the location of the operation of the prior call in the updated WSDL operation list and/or in response to a user selecting an operation from the plurality of operations provided, at 224, XML schema validation can be performed. Validation of an XML schema can include determining if an XML document conforms to a schema, or in other words, if the document is valid. For example, a document may be valid if the document satisfies the requirements of the XML schema the document is associated with.

At 226, the call for the service within the service test can be converted from a prior WSDL call to an updated WSDL call. Converting a call can include automatically mapping a plurality of prior WSDL call properties to a plurality of updated WSDL call properties, for example. An updated WSDL call can include a converted call, for instance.

A determination can be made, at 228, as to whether the prior WSDL call properties can be located in the updated WSDL call. For example, input and output properties of the prior WSDL call, for which data, links, and/or checkpoints have been defined, can be located in the updated WSDL call properties.

In response to not locating the updated WSDL call location of the prior WSDL call properties, at 230, the converted call can be flagged. At 232, if a converted call has been flagged because of an inability to automatically find the location of the prior WSDL call properties, a list of prior WSDL call properties and updated WSDL call properties can be provided to a user. The list can be provided to the user for the user to select updated WSDL call properties that can be mapped to prior WSDL call properties from the list.

In response to locating the updated WSDL call location of the prior WSDL call properties and/or in response to a user selecting an updated WSDL call location of the prior WSDL call properties, at 234, request and response data can be copied from the prior WSDL call to the converted call. The request and response data can be automatically copied, for example. Copying request and response data can include, for instance, copying all request and response data from the prior WSDL call.

In various examples of the present disclosure, in response to a flagged converted call, a user can be presented with a number of options for resolving the flag. For example, options for resolving the flag can include deleting the converted call or test, ignoring the updated WSDL, or manually updating the converted call. Ignoring the updated WSDL can include ignoring a conflict between the call for the service within the service test and the updated WSDL for the service, for instance. Ignoring a conflict can result in the test being prevented from running while the conflict exists. Manually updating the converted call can include providing a list of a plurality of updated WSDL operations (e.g. at illustrated in FIG. 2 at 228) and the user selecting an operation from the list, for example.

In some examples of the present disclosure, the hierarchy of the service items for the updated WSDL can be displayed on a user interface. For example, the hierarchy can be displayed in response to a user selecting to apply the updated WSDL. Applying the updated WSDL can include updating the WSDL for the service in the service test. In various examples of the present disclosure, a graphic can be displayed of the updated WSDL schema compared to the prior WSDL schema on the user interface.

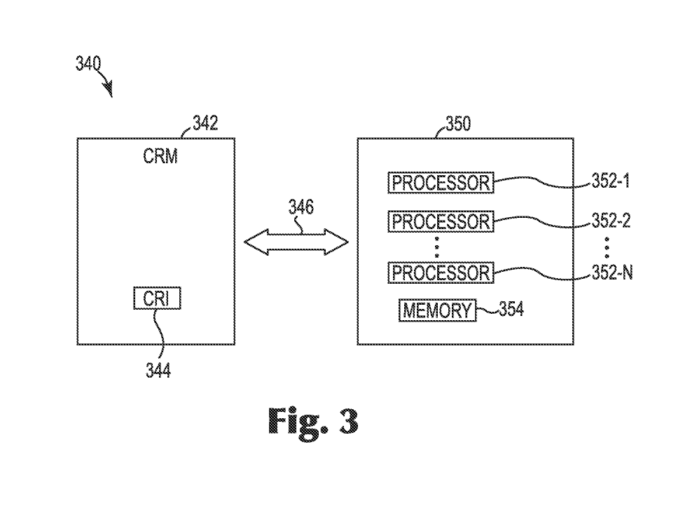

FIG. 3 is a block diagram 340 of an example of a computer-readable medium 342 in communication with processing resources 352-1, 352-2 . . . 352-N for updating a WSDL for a service test according to the present disclosure. Computer-readable medium (CRM) 342 can be in communication with a computing device 350 having processor resources of more or fewer than 352-1, 352-2 . . . 352-N, that can be in communication with, and/or receive a tangible non-transitory CRM 342 storing a set of computer-readable instructions 344 executable by one or more of the processor resources 352-1, 352-2 . . . 352-N for updating a WSDL for a service test. The computing device 350 may include memory resources 354, and the processor resources 352-1, 352-2 . . . 352-N may be coupled to the memory resources 354.

Processor resources can execute computer-readable instructions 344 for updating a WSDL for a service test and are stored on an internal or external non-transitory CRM 342. A non-transitory CRM (e.g., CRM 342), as used herein, can include volatile and/or non-volatile memory. Volatile memory can include memory that depends upon power to store information, such as various types of dynamic random access memory (DRAM), among others. Non-volatile memory can include memory that does not depend upon power to store information. Examples of non-volatile memory can include solid state media such as flash memory, EEPROM, phase change random access memory (PCRAM), magnetic memory such as a hard disk, tape drives, floppy disk, and/or tape memory, optical discs, digital versatile discs (DVD), Blu-ray discs (BD), compact discs (CD), and/or a solid state drive (SSD), flash memory, etc., as well as other types of CRM.

The non-transitory CRM 342 can be integral, or communicatively coupled, to a computing device (e.g. computing device 350), in either in a wired or wireless manner. For example, the non-transitory CRM 342 can be an internal memory, a portable memory, a portable disk, or a memory located internal to another computing resource (e.g., enabling the computer-readable instructions 344 to be downloaded over the Internet).

The CRM 342 can be in communication with the processor resources 352-1, 352-2 . . . 352-N via a communication path 346. The communication path 346 can be local or remote to a machine associated with the processor resources 352-1, 352-2 . . . 352-N. Examples of a local communication path 346 can include an electronic bus internal to a machine such as a computer where the CRM 342 is one of volatile, non-volatile, fixed, and/or removable storage medium in communication with the processor resources 352-1, 352-2 . . . 352-N via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof.

The communication path 346 can be such that the CRM 342 is remote from the processor resources (e.g., processor resources 352-1, 352-2 . . . 352-N) such as in the example of a network connection between the CRM 342 and the processor resources 352-1, 352-2 . . . 352-N. That is, the communication path 346 can be a network connection. Examples of such a network connection can include a local area network (LAN), a wide area network (WAN), a personal area network (PAN), and the Internet, among others. In such examples, the CRM 342 may be associated with a first computing device and the processor resources 352-1, 352-2 . . . 352-N may be associated with a second computing device.

Processor resources 352-1, 352-2 . . . 352-N coupled to the memory resources 354 can detect an updated version of a WSDL for a service. The processor resources 352-1, 352-2 . . . 352-N coupled to the memory resources 354 can map the updated version of a WSDL operation to a prior version of the WSDL operation for the service test. The processor resources 352-1, 352-2 . . . 352-N coupled to the memory resources 354 can update a call for the service within the service test by converting the call from a prior WSDL call to an updated WSDL call. The update can occur automatically. Converting the call can include automatically mapping a plurality of prior WSDL call properties to a plurality of updated WSDL call properties, for example. The processor resources 352-1, 352-2 . . . 352-N coupled to the memory resources 354 can copy request and response data from the prior WSDL call to the updated WSDL call. Request and response data can include values from the prior WSDL call operation request and response messages that can be used in the updated WSDL call operation, for example.

The above specification, examples and data provide a description of the method and applications, and use of the system and method of the present disclosure. Since many examples can be made without departing from the spirit and scope of the system and method of the present disclosure, this specification merely sets forth some of the many possible example configurations and implementations.

Although specific examples have been illustrated and described herein, those of ordinary skill in the art will appreciate that an arrangement calculated to achieve the same results can be substituted for the specific examples shown. This disclosure is intended to cover adaptations or variations of one or more examples of the present disclosure. It is to be understood that the above description has been made in an illustrative fashion, and not a restrictive one. Combination of the above examples, and other examples not specifically described herein will be apparent to those of skill in the art upon reviewing the above description. The scope of the one or more examples of the present disclosure includes other applications in which the above structures and methods are used. Therefore, the scope of one or more examples of the present disclosure should be determined with reference to the appended claims, along with the full range of equivalents to which such claims are entitled.

What is claimed:

1. A method for updating a web services description language (WSDL) for a service test, comprising:
identifying a first WSDL and a second WSDL for a service;
mapping the first WSDL to the second WSDL; and
performing an action to update a call within the service test from the second WSDL to the first WSDL.

2. The method of claim 1, wherein the first WSDL includes an updated version of the second WSDL.

3. The method of claim 1, wherein performing an action includes converting the call for the service from a second WSDL call to a first WSDL call.

4. The method of claim 1, wherein performing an action includes at least one of deleting the call, ignoring the first WSDL, and providing a manual update procedure.

5. The method of claim 1, comprising automatically transferring security settings from the second WSDL to the first WSDL.

6. The method of claim 1, comprising providing a manual procedure for transferring security settings in response to a security setting that cannot be automatically transferred from the second WSDL to the first WSDL.

7. A non-transitory computer-readable medium storing a set of instructions executable by a computer to cause the computer to:
detect an updated web services description language (WSDL) for a service;
map an updated WSDL operation to a prior WSDL operation; and
update a call for the service within a service test by converting the call from a prior WSDL call to an updated WSDL call.

8. The non-transitory computer-readable medium of claim 7, wherein the set of instructions executable by the computer to cause the computer to detect an updated WSDL for a service includes instructions to detect a change to at least one of service name, the service endpoint, port names, operation names, the operation request, and response schemas of the prior WSDL.

9. The non-transitory computer-readable medium of claim 7, wherein the set of instructions executable by the computer further cause the computer to provide a user with an option to ignore the updated WSDL for the service test.

10. The non-transitory computer-readable medium of claim 7, wherein the set of instructions executable by the computer further cause the computer to:
perform an XML schema validation in response to determining an updated WSDL location of the operation of the prior WSDL call;
map a plurality of prior WSDL call properties to a plurality of updated WSDL call properties; and
copy request and response data from the prior WSDL call to the converted WSDL call.

11. The non-transitory computer-readable medium of claim 7, wherein the set of instructions executable by the computer further cause the computer to:
flag the converted call in response to not determining an updated WSDL location of the operation of the prior WSDL call;
provide a list of a plurality of updated WSDL operations for the service; and
perform an XML schema validation, map a plurality of prior WSDL call properties to a plurality of updated WSDL call properties, and copy request and response data from the prior WSDL call to the converted WSDL call in response to a user selection of an updated WSDL operation.

12. A computing system for updating a web services description language (WSDL) for a service test, comprising:
memory resources; and
processor resources coupled to the memory resources, to:
detect an updated version of a WSDL for a service;
map the updated version of the WSDL operation to a prior version of the WSDL operation for the service;
update a call for the service within the service test by converting the call from a prior WSDL call to an updated WSDL call; and
copy request and response data from the prior WSDL call to the updated WSDL call.

13. The system of claim 12, wherein the processor resources are further coupled to the memory resources to display a hierarchy of service items for the updated version of the WSDL on a user interface.

14. The system of claim 12, wherein the processor resources are further coupled to the memory resources to display a graphic, on a user interface, of a prior version of the WSDL schema compared to an updated version of the WSDL schema.

15. The system of claim 12, wherein the processor resources are further coupled to the memory resources to automatically map a plurality of prior WSDL call properties to a plurality of updated WSDL call properties to update the call for the service within the service test.
